(19) United States
(12) Patent Application Publication
(10) Pub. No.: US 2009/0163273 A1
(43) Pub. Date: Jun. 25, 2009

(54) HANDHELD VIDEO PLAYER AND OPTICAL STORAGE DISC FOR USE THEREWITH

(76) Inventor: Feng Chi Wang, Austin, TX (US)

Correspondence Address: GARLICK HARRISON & MARKISON, P.O. BOX 160727, AUSTIN, TX, 78716-0727, US

(21) Appl. No.: 11/960,076

(22) Filed: Dec. 19, 2007

(51) Int. Cl. A63F 13/00; G11B 23/03

(52) U.S. Cl. 463/31; 463/43; 720/728

(57) ABSTRACT

An optical storage disc can be used in a handheld video player that includes a processing module, an interface module for receiving a video signal, and a display device. The optical storage disc includes a first portion that stores conditional access data and a second portion that stores a plurality of operational instructions including a video player application. When the optical storage disc is loaded in the handheld video player and when the plurality of operational instructions are executed by the processing module, the video player application descrambles the video signal received from the interface module using the conditional access data and displays video content from the video signal on the display device.

### TECHNICAL FIELD OF THE INVENTION

The present invention relates to transfer of media content and related methods used in devices such as set-top boxes and other home media gateways.

### DESCRIPTION OF RELATED ART

Many video game consoles have developed handheld versions that allow users to play games when on the go. Examples include the Nintendo Gameboy series and Sony PlayStation Portable series of portable game consoles. These portable game consoles have increased in functionality beyond just gaming. For instance, the Sony PlayStation Portable, can be equipped with a digital TV receiver, global positioning system (GPS) receiver, a digital camera, an Internet browser, etc.

Portable game consoles generally operate based on a game cartridge or disc for loading the software for a particular game. Switching games is accomplished by switching cartridges or discs. The Sony PlayStation includes an optical disc drive that reads a Universal Media Disc (UMD) that can hold up to 1.8 gigabytes of data. Prerecorded UMDs can be purchased with video programs that allow users to watch television programs or movies on the portable game consoles.

The UMD format has a limited market and many titles are not available in this format. As a result, Sony PlayStation users have a relatively limited selection of video programs available.

### BRIEF DESCRIPTION OF THE SEVERAL VIEWS OF THE DRAWINGS

FIG. 1 presents a pictorial representation of a handheld video player 10 in accordance with an embodiment of the present invention.

FIG. 2 presents a block diagram representation of handheld video player 10 in accordance with an embodiment of the present invention.

FIG. 3 presents a pictorial representation of a optical storage disc 75 and selected portions of the data stored thereon in accordance with an embodiment of the present invention.

FIG. 4 presents a pictorial representation of a display screen 230 that includes a user set-up menu in accordance with an embodiment of the present invention.

FIG. 5 presents pictorial representation of a display screen 240 that includes an inserted advertisement in accordance with an embodiment of the present invention.

FIG. 6 presents representation of the timing of advertisements inserted in displayed video content in accordance with an embodiment of the present invention.

FIG. 7 presents representation of the timing of advertisements inserted in displayed video content in accordance with an embodiment of the present invention.

FIG. 8 presents representation of the timing of advertisements inserted in displayed video content in accordance with an embodiment of the present invention.

FIG. 9 presents a flowchart representation of a method in accordance with an embodiment of the present invention.

FIG. 10 presents a flowchart representation of a method in accordance with an embodiment of the present invention.

FIG. 11 presents a flowchart representation of a method in accordance with an embodiment of the present invention.

FIG. 12 presents a flowchart representation of a method in accordance with an embodiment of the present invention.

FIG. 13 presents a flowchart representation of a method in accordance with an embodiment of the present invention.

FIG. 14 presents a flowchart representation of a method in accordance with an embodiment of the present invention.

### DETAILED DESCRIPTION OF THE INVENTION INCLUDING THE PRESENTLY PREFERRED EMBODIMENTS

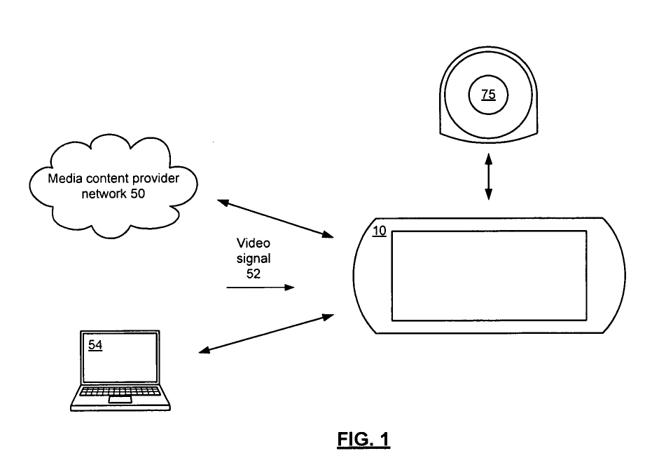

FIG. 1 presents a pictorial representation of a handheld video player 10 in accordance with an embodiment of the present invention. In particular, handheld video player 10 is shown that can receives a video signal 52 from an external device such as media content provider network 50 or computer 54. The handheld video player is coupleable to a removable storage media via a drive or port. In the embodiment shown handheld media player 10 includes an optical disc drive that receives an optical storage disc 75 such as a UMD format optical storage disc, compact disc read only memory (CDROM) digital video disc read only memory (DVDROM), or other optical storage media and is capable of accessing data stored on the disc. The handheld video player can be a dedicated video player that displays video content based on the video signal 52, stored video content or video content received from another source and/or includes one or more other functions such that of a portable game console, Internet browser, GPS receiver, a digital camera or camcorder, a wireless telephone such as a cellular phone or other wireless telephony device.

Handheld video player 10 can be directly coupled to media content provider network 50 or personal computer 54 to receive video signal 52 via a server, set-top box, personal computer, wireless local area network (WLAN) access point, cable television receiver, satellite broadcast receiver, broadband modem, 3G transceiver or other gateway or device that is capable of transferring a video signal 52 from media content provider network 50 or personal computer 54.

The video signal 52 can be in the form of one or more video signals, optionally including associated audio signals that are either realtime signals in analog or digital format or data files that contain video signals 52 in a digital format. In general, video signal 52 can include an analog video signal that is formatted in any of a number of video formats including National Television Systems Committee (NTSC), Phase Alternating Line (PAL) or Sequentiel Couleur Avec Memoire (SECAM). Alternatively, video signal 52 can be in a digital format such as a Motion Picture Experts Group (MPEG) format (such as MPEG1, MPEG2 or MPEG4), Quicktime format, Real Media format, H.264 format, Windows Media Video (WMV) or Audio Video Interleave (AVI), or another digital video format, either standard or proprietary.

For instance, video signal 52 can be included in a broadcast video signal, such as a television signal, high definition televisions signal, enhanced high definition television signal or other broadcast video signal that has been transmitted over a wireless medium, either directly or through one or more satellites or other relay stations or through a cable network, optical network, IP television network, or other transmission network. Further, video signal 52 can be included in a digital audio/video file, transferred from a storage medium such as a server memory, magnetic tape, magnetic disc or optical disc, or can be included in a streaming audio or video signal that is transmitted over a public or private network such as a wireless or wired data network, local area network, wide area network, metropolitan area network or the Internet.

Handheld video player 10 can be coupled to display video content from video signal 52 on its own display device or optionally, via a coupling to an external display device such as computer monitor, television receiver, et cetera. In an embodiment of the present invention, handheld video player 10 includes a wired link for coupling to media content provider network 50 and/or personal computer 54 to transfer the video signal 52. The coupling can include a serial or parallel connection such as an Ethernet connection, Universal Serial Bus (USB) connection, an Institute of Electrical and Electronics Engineers (IEEE) 1394 (Firewire) connection, small computer serial interface (SCSI) connection or other wired connection that operates in accordance with either a standard or custom interface protocol.

In addition or in the alternative, the handheld video player 10 includes a wireless link for coupling to the media content provider network 50 and/or personal computer 54 that operates in accordance with a wireless network protocol such as 802.11a,b,g,n (referred to generically as 802.11x), Bluetooth, Ultra Wideband (UWB) or other wireless connection that operates in accordance with either a standard or custom interface protocol in order to transfer video signal 52 from one or more of these external devices.

In operation, the optical storage disc 75 stores conditional access data and a plurality of operational instructions including a video player application. When the optical storage disc is loaded in the handheld video player 10 and when the plurality of operational instructions are executed, the video player application descrambles the video signal 52 received from the interface module using the conditional access data and displays video content from the video signal on the display device. In a further embodiment, the optical storage disc 75 also stores a plurality of advertising data. The video player application can insert advertisements in the displayed video content derived from the plurality of advertising data.

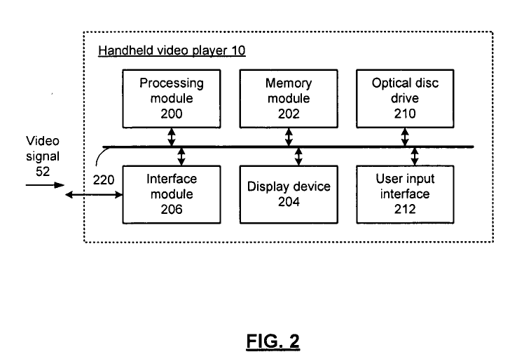

Various implementations of the present invention including several optional functions and features are described further in conjunction with FIGS. 2-10 that follow.

FIG. 2 presents a block diagram representation of handheld video player 10 in accordance with an embodiment of the present invention. In particular, a handheld video player 10 is shown that includes a processing module 200, memory module 202, optical disc drive 210, interface module 206, display device 204 and user input interface 212, that are coupled via bus 220. While a particular bus architecture is shown, other architectures that include two or more buses and/or direct connectivity between one or more modules of handheld video player 10 are also possible within the scope of the present invention.

In an embodiment of the present invention, the interface module 206 receives video signal 52 from an external device such as media content network 50 or personal computer 54. The interface module 206 can include one or more wired serial or parallel ports such as an Ethernet port, Universal Serial Bus (USB) port, an Institute of Electrical and Electronics Engineers (IEEE) 1394 (Firewire) port, small computer serial interface (SCSI) port or other wired connection or port that operates in accordance with either a standard or custom interface protocol. In addition or in the alternative, interface module 206 includes a wireless transceiver for coupling to the media content provider network 50 and/or personal computer 54 that operates in accordance with a wireless network protocol such as 802.11a,b,g,n (referred to generically as 802.11x), Bluetooth, Ultra Wideband (UWB), Infrared Data Association (IrDA) or other wireless connection that operates in accordance with either a standard or custom interface protocol in order to transfer video signal 52 from one or more of these external devices.

In addition, interface module 206 can include a port, such as a card slot or other connection that is coupleable to a removable memory device such as a memory stick, memory card, flash memory device or other memory that transfers video signal 52 via file transfer of a compressed digital video file.

Optical disc drive 210 is included for reading an optical storage disc 75 such as a UMD, CDROM, DVDROM or other optical media that stores data such as conditional access data, a video player application and advertising data. In an embodiment of the present invention, processing module 200, coupled to the interface module executes a video player application to optionally descramble the video signal 52 based on the conditional access data to produce a descrambled video signal, and to decode the video signal to produce a decoded video signal for display on display device 204 such as a liquid crystal display, plasma display device or other display device. In a further embodiment of the present invention, processing module 200 executes the video player application to optionally descramble and decodes the video signal 52 and produces a decoded video signal that includes at least one advertisement from the plurality of advertising data.

Processing module 200 can be implemented using a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory module 202. Memory module 202 may be a single memory device or a plurality of memory devices. Such a memory device can include a hard disc drive or other disc drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

Memory module 202 can store the video player application, conditional access data and/or advertising data and other data read from the optical storage disc 75 via optical disc drive 210. In addition, memory module 202 can store a resident video player application that may be different from the video player application loaded from optical storage disc 75, user selections, preferences and other user attribute data, application data corresponding to other applications of the handheld video player 10, the operating system, other software and firmware, and other data. Additionally, memory module 202 can store a plurality of compressed video files corresponding to stored instances of video signal 52. As discussed above, memory module 202 can include a plurality of different memory devices such as random access memory (RAM), read only memory (ROM), and removable storage devices. In an embodiment of the present invention, memory module 202 includes a flash memory card, memory stick or other flash memory device.

The other modules of handheld device 10 can be implemented in software, firmware or hardware, depending on the particular implementation of processing module 200.

In an embodiment of the present invention, the video signal 52 is scrambled such as by encryption, coding other conditional access technique for the purposes of digital rights management or otherwise to prevent video signal 52 being accessed, either partially or fully, by users that are not in possession of certain conditional access data. The conditional access data can include one or more access keys such as encryption keys, passwords or other data that allows the video signal 52 to be descrambled for decoding and display. As discussed, video signal 52 can be a compressed digital video signal such as a MPEG2, H.264 or compressed digital video signal in another digital format. Processing module 200 operates to descramble and decode the video signal 52 based on descrambling and decoding submodules that are implemented in hardware, software or firmware.

In a mode of operation, the conditional access data includes an expiration date and the access key or keys are not operational to descramble the video signal 52 after the expiration date. This can be accomplished in different ways, the conditional access data can include an expiration data that is read by the video player application and compared to the actual data supplied by a real time clock or other device (not expressly shown). When the video player application is launched and commanded, via user input received via user input interface 212, to commence the viewing of a particular video signal 52, the actual date is compared with the expiration data and the display of the video signal 52. In these circumstances, the attempted descrambling, decoding and display of the video signal 52 is aborted and the handheld video player 10 displays a message generated by the video player application on the display device 204 that video signal 52 cannot be displayed or more specifically that the access has expired.

In an alternative embodiment of the present invention, the key or keys used to scramble the video signal 52 are changed periodically. A key expires when a video signal 52 is received that is encoded with an updated access key that is not included in the conditional access data loaded from optical storage media 75. In this circumstance, the video player application may attempt to descramble a particular video signal 52 and determine, via decoding checksums or other comparisons that the access key currently being employed in the descrambling processes is not the proper access key for descrambling the current video signal 52. In these circumstances, the attempted descrambling, decoding and display of the video signal 52 is aborted and the handheld video player 10 displays a message generated by the video player application on the display device 204 that video signal 52 cannot be displayed or more specifically that the access has expired.

In an embodiment of the present invention, the handheld video player 10 includes a secure file transfer application as one of the suite of applications stored in memory module 202. This secure file transfer application decodes the conditional access data from the optical storage disc and stores the conditional access data in a portion of memory module 202, such as in RAM or a flash memory card, removable memory stick or other flash memory device. The secure file transfer application protects the conditional access data from unauthorized copying and/or from other unauthorized access during the transfer process as well as after the conditional access data has been stored in memory module 202.

It should be noted that handheld video player 10 can also have a resident video player application that is stored in memory module 202, or implemented in hardware or firmware. This resident video player application can be used for decoding, displaying and optionally descrambling the video signal 52 52. This resident video player application can be used by handheld video player 10 in the absence of the video player application loaded from optical storage disc 75, or can be selectively executed in place of the video player application loaded from optical storage disc 75 under either user control or based on data or other indicator included in video signal 52, etc.

In an embodiment of the present invention, the optical storage disc 75 includes conditional access data and a video player application that is customized to a particular set of video content received as video signal 52. For instance, access to special programming such as a particular sporting event, movie on demand, pay-per-view event or access to one or more particular movies or other video content is scrambled with conditional access data that is made available on optical storage disc 75. While the user of handheld video player 10 can optionally receive and display other video content received via video signal 52. The user of handheld video player 10 can descramble, decode and display this particular video content only if he or she has obtained the appropriate optical storage disc 75 that includes the conditional access data required to descramble the video signal 52 containing this special programming.

In one example, the a sponsor of special programming such as a special movie presentation, sporting event or pay-per-view event could distribute optical storage discs 75 for a fee to access the special programming. In the alternative, these optical storage discs could be distributed by a sponsor in association with other goods and services for instance or otherwise on a free basis as part of an ad campaign or other promotion.

In a further example, a service provider such as a broadcaster, cable company, IP television service or other service provider could use optical storage discs as a mechanism for providing subscribers access to programming provided to their subscribers. In this case the subscriber is issued an optical storage disc 75 in exchange for a subscription fee that is a one-time fee or periodic fee or that optionally corresponds to a subscription period that coincides with the time to expiration of the access key or other conditional access data. In this fashion, the subscriber can access the service provider's programming during the period of the subscription.

As discussed above, the video player application stored on optical storage disc 75 (the loaded video player application as opposed to the resident video player application) can be selectively accessed and executed by processor 200 of handheld video player 10. In an embodiment of the present invention, the loaded video player application can be used whenever the optical storage disc 75 is inserted in the optical disc drive 210, whenever video signal 52 includes a flag or other data indicating that the loaded video player application should be executed, such as an indicator included in a video signal 52 corresponding to special programming discussed above. In this fashion, when special programming is accessed via video signal 52, the loaded video player application can automatically be launched. When other programming is accessed via video signal 52 or as a default, the resident video player can be launched. In the alternative the loaded video player application can be used as the default video player once loaded.

In an embodiment of the present invention, the loaded video player application includes additional functions that apply to the descrambling of a video signal 52 that are required for the descrambling of special programming. In addition or in the alternative the loaded video player can include additional features that correspond to special programming such as access to corresponding internet data associated with the special programming accessible via an internet browser of the handheld video player, enhanced fast forward, pause, and rewind of video content, access to special bonus features or interactive content of the video content or other enhanced features that may only be available through use of the loaded video player application. Further, the loaded video player might also be designed to operate on a broader set of video signals 52 and not limited to a special programming scenario and some or all these advanced functions and features may be accessible for a broader range of programming.

As discussed above, in a further mode of operation, the optical storage disc 75 also stores a plurality of advertising data and the video player application loaded from the optical storage disc operates to decode the video signal 52 to include at least one advertisement derived from the plurality of advertising data. In various embodiments, the video player application inserts an advertisement prior to, during or after the video content, such as prior to a movie, pay-per-view event, or sporting event. For example, in circumstances where the video signal 52 is transferred as a stored video file, and the decoding of the video signal is performed on a non-realtime basis, the advertisement can be concatenated to the beginning or end of the video content of video signal 52. Further, the video content can be segmented into a plurality of segments, either based on ad insertion tags or other indicators included in the encoding of the video signal 52 that identify ad insertion slots or other break points or by monitoring the decoded video signal and identifying portions of the video content that correspond to changes of scene, etc. In circumstances where the video signal 52 is a realtime signal such as a broadcast video signal, streaming video signal or other realtime or near realtime signal, the video player application can insert an advertisement at the end of the video content, or during ad insertion slots that are identified by ad insertion tags or other indicators.

In the alternative, the video player application can buffer the video signal 52 (particularly in buffering applications that allow the user to pause, rewind and fast forward live broadcasts). The buffering of the video signal 52 facilitates the insertion advertisements at the beginning or within the video content since the buffering of the video signal 52 effectively converts the realtime video signal 52 into a non-realtime video signal that can be manipulated, segmented, et cetera as discussed above.

In a mode of operation, the video player application can select a particular advertisement from the plurality of advertising data based on either a content attribute associated with the video signal 52 or a user attribute associated with the user. For instance, the video signal 52 can be encoded with a Motion Picture Association of America (MPAA) rating such as G, PG, PG13 or R and the video player application can correlate this rating to ad content. For example when a G rated movie is playing, ads for children's products, young families, movies with the same or similar rating can be including with the showing and targeted to the expected viewers. Further, information on the genre of the programming can also be included in the video signal 52 such as family, action thriller, romantic comedy, sports programming, children's cartoon, etc, so that these genres can be used by the video player application to select a advertisements that may be correlated to the expected viewers of these programs.

In addition, information relating to a particular user such as prior viewing selections, user selected preferences, demographic information entered by the user, or other user attributes can be correlated to particular advertisements to target the advertisement to users having these user attributes. For instance, the video player application can insert targeted advertisements such as hot new games, children's shows and entertainment venues for younger viewers while targeting advertisements for auto loans and apartment finding services for young adults.

When the optical storage disc 75 includes advertising the disc provider can sell ad insertion slots to third party advertisers. The availability of targeted advertising for these third party ads can be used by the disc provider to promote and/or price the advertisements based on the particular user attributes and content attributes associated with each third party advertisement.

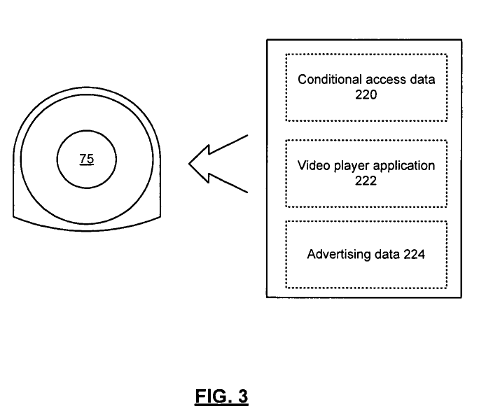

FIG. 3 presents a pictorial representation of a optical storage disc 75 and selected portions of the data stored thereon in accordance with an embodiment of the present invention. In particular, optical storage disc 75 stores, in portions of the storage conditional access data 220, a plurality of operational instructions including a video player application 222 and a plurality of advertising data 224 as discussed in conjunction with optical storage disc 75 in conjunction with FIGS. 1-2. As discussed above, the optical storage disc 75 can be implemented as a universal media disc for use with a portable game console, such as a Sony PlayStation Portable or other handheld video player.

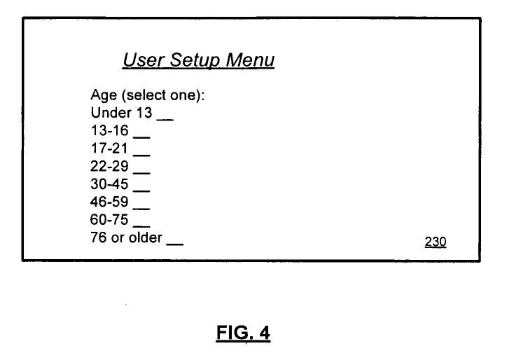

FIG. 4 presents a pictorial representation of a display screen 230 that includes a user set-up menu in accordance with an embodiment of the present invention. In particular, in this embodiment the user is queried to enter user attributes, in this case the age of the user, via display screen 230. A set-up application included in the video player application or other application of handheld video player 10 solicits this information by displaying a menu on the display device and receiving input via a touch screen, buttons, thumb wheel or other user input devices included as part of user input interface 212.

In this fashion, demographic information, preferences or other user attributed relating to one or more users can be solicited and received by the handheld video player 10 and stored in memory module 202 for use in conjunction with the selection of targeted advertisements as discussed above in conjunction with FIG. 2. When user attributes associated with a plurality of users of the handheld video player 10 are stored in this fashion, the identity of the particular user or users of the device may be solicited or other selected in conjunction of the display of a particular video signal 52.

FIG. 5 presents pictorial representation of a display screen 240 that includes an inserted advertisement in accordance with an embodiment of the present invention. In this example, a portion of an advertisement for Morega Systems, Inc. is shown as display screen 240. The advertising data associated with this display screen such as a video signal corresponding to the advertisement can be digitized, compressed and stored on the optical storage disc 75 as a compressed digital video file. When this particular advertisement is selected for insertion in the video signal 52, the compressed digital video file is decoded and the frames of the video signal are added to the beginning or end of the frames of the decoded video content from video signal 52 or in a advertisement segment between two segments of the frames from the video content of video signal 52.

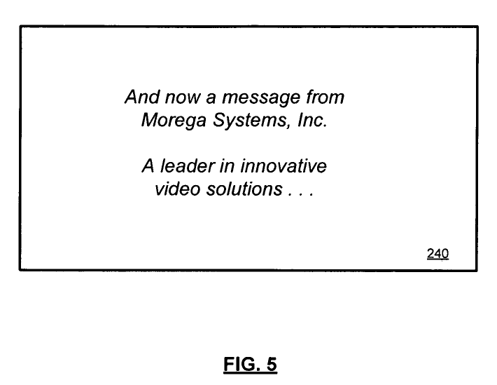

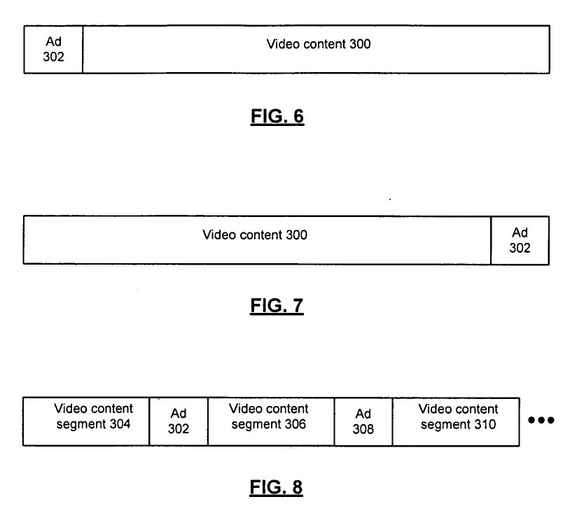

FIG. 6 presents representation of the timing of advertisements inserted in displayed video content in accordance with an embodiment of the present invention. In this example, an ad 302 is appended to the beginning of video content 302 from video signal 52.

FIG. 7 presents representation of the timing of advertisements inserted in displayed video content in accordance with an embodiment of the present invention. In this example, an ad 302 is appended to the end of video content 302 from video signal 52.

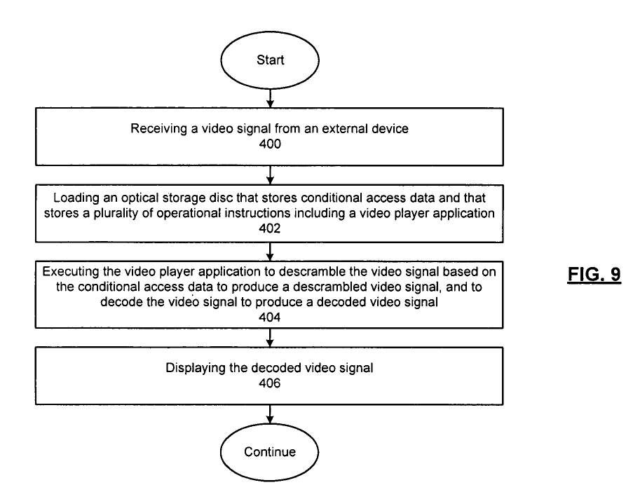

FIG. 8 presents representation of the timing of advertisements inserted in displayed video content in accordance with an embodiment of the present invention. In this example, ads 302 and 308 are inserted between segments 304, 306 and 310 of the video content of video signal 52. As discussed in conjunction with FIG. 2, these video segments can be formed by the video player application, such as video player application 222 or demarcated by ad insertion tags or other indicators included in video signal 52.

FIG. 9 presents a flowchart representation of a method in accordance with an embodiment of the present invention. In particular a method is presented for use in conjunction with one or more of the functions and features presented in conjunction with FIGS. 1-8. In step 400 a video signal is received from an external device. In step 402, an optical storage disc is loaded that stores conditional access data and that stores a plurality of operational instructions including a video player application. In step 404, a video player application is executed to descramble the video signal based on the conditional access data to produce a descrambled video signal, and to decode the video signal to produce a decoded video signal. In step 406, the decoded video signal is displayed.

In an embodiment of the present invention, the optical storage disc includes a universal media disc. The conditional access data can includes at least one access key for descrambling the video signal and/or an expiration date and the at least one access key is not operational to descramble the video signal after the expiration date. Stop 400 can receive the video signal via a interface module that includes at least one of, an Ethernet port, a universal serial bus port, and a wireless local area network port.

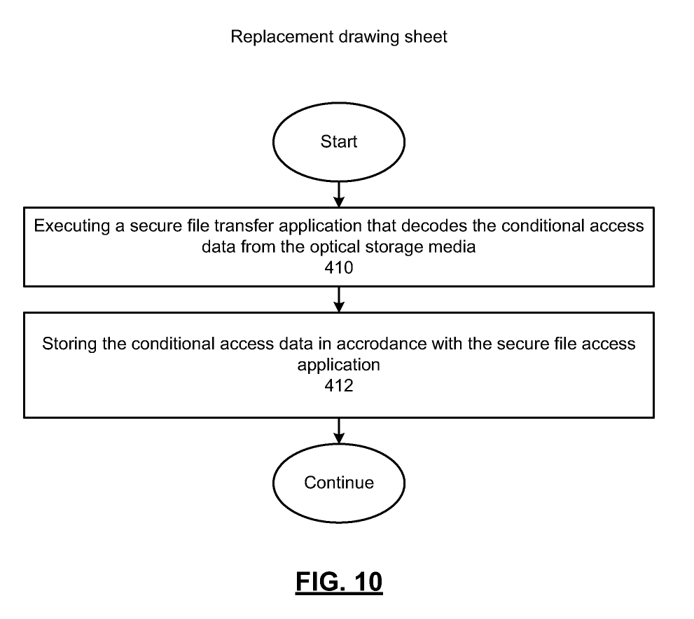

FIG. 10 presents a flowchart representation of a method in accordance with an embodiment of the present invention. In particular a method is presented for use in conjunction with the method discussed in association with FIG. 9. In step 410, a secure file transfer application is executed that decodes the conditional access data from the optical storage disc. In step 412, the conditional access data is stored in accordance with the secure file transfer application.

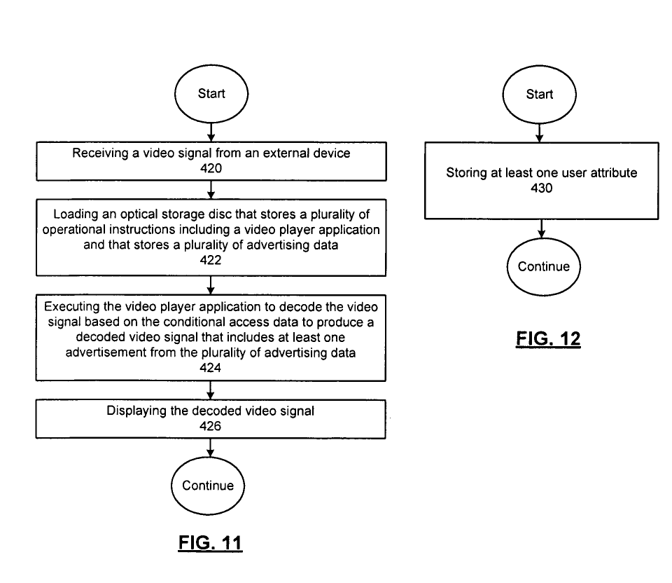

FIG. 11 presents a flowchart representation of a method in accordance with an embodiment of the present invention. In particular a method is presented for use in conjunction with one or more functions and features in association with FIGS. 1-10. In step 420, a video signal is received from an external device. In step 422, an optical storage disc is loaded that stores a plurality of operational instructions including a video player application and a plurality of advertising data. In step 424, the video player application is executed to decode the video signal and produce a decoded video signal that includes at least one advertisement from the plurality of advertising data. In step 426, the decoded video signal is displayed.

In an embodiment of the present invention, the video signal includes video content and wherein the video player application inserts the at least one advertisement prior to the video content. The can include video content and the video player application can insert the at least one advertisement within the video content. In addition or in the alternative, the video signal can include a content attribute and wherein the video player application selects the at least one advertisement based on the content attribute. Step 420 can include receiving a video signal via at least one of, an Ethernet port, a universal serial bus port, and a wireless local area network port.

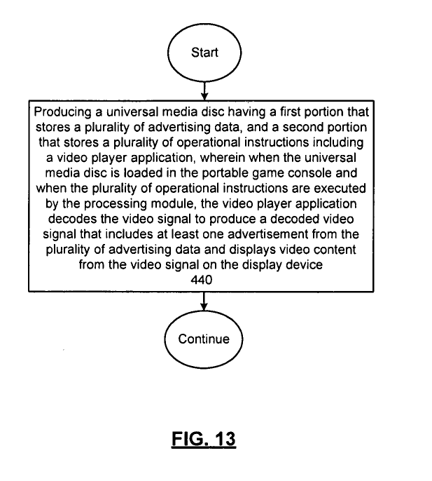

FIG. 12 presents a flowchart representation of a method in accordance with an embodiment of the present invention. In particular a method is presented for use in conjunction with the method presented in association with FIG. 11. In step 430, at least one user attribute is stored, wherein the video player application selects the at least one advertisement based on the user attribute.

FIG. 13 presents a flowchart representation of a method in accordance with an embodiment of the present invention. In particular a method is presented for use in conjunction with one or more functions and features in association with FIGS. 1-12. In step 440, a universal media disc is produced having a first portion that stores a plurality of advertising data, and a second portion that stores a plurality of operational instructions including a video player application. When the universal media disc is loaded in the portable game console and when the plurality of operational instructions are executed by the processing module, the video player application decodes the video signal to produce a decoded video signal that includes at least one advertisement from the plurality of advertising data and displays video content from the video signal on the display device.

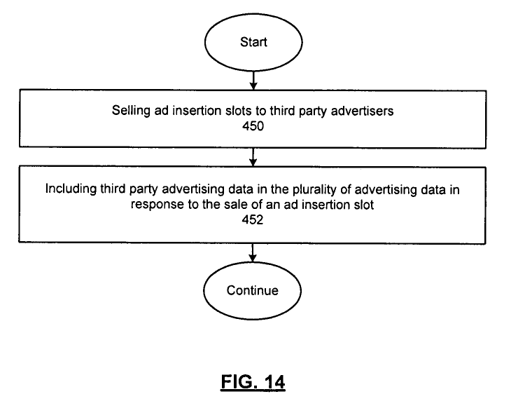

FIG. 14 presents a flowchart representation of a method in accordance with an embodiment of the present invention. In particular a method is presented for use in conjunction with the method presented in association with FIG. 13. In step 450, ad insertion slots are sold to third party advertisers. In step 452, third party advertising data are included in the plurality of advertising data in response to the sale of an ad insertion slot.

In an embodiment of the present invention, the video signal includes video content and a content attribute and wherein the video player application selects the at least one advertisement based on the content attribute and the ad insertion slot can be sold based on the content attribute. The video player application can select the at least one advertisement based on a user attribute and further ad insertion slots can be sold based on the user attribute.

In preferred embodiments, optional circuit components can be implemented using 0.35 micron or smaller CMOS technology. Provided however that other circuit technologies, both integrated or non-integrated, may be used within the broad scope of the present invention.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As the term module is used in the description of the various embodiments of the present invention, a module includes a functional block that is implemented in hardware, software, and/or firmware that performs one or module functions such as the processing of an input signal to produce an output signal. As used herein, a module may contain submodules that themselves are modules.

Thus, there has been described herein an apparatus and method, as well as several embodiments including a preferred embodiment, for implementing a handheld video player such as a portable game console and an optical storage disc such as a UMD for use therewith. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A portable game console comprising:
a interface module for receiving a video signal;
an optical disc drive for loading a universal media disc that stores conditional access data and that stores a plurality of operational instructions including a first video player application;
a processing module, coupled to the interface module and the optical disc drive, that executes the first video player application to descramble the video signal based on the conditional access data to produce a descrambled video signal, and to decode the video signal to produce a decoded video signal; and
a display device, coupled to the processing module, that displays that decoded video signal.

2. The portable game console of claim 1 wherein the conditional access data includes at least one access key for descrambling the video signal.

3. The portable game console of claim 2 wherein the conditional access data includes an expiration date and the at least one access key is not operational to descramble the video signal after the expiration date.

4. The portable game console of claim 1 wherein the interface module includes at least one of, an Ethernet port, a universal serial bus port, and a wireless local area network port.

5. The portable game console of claim 1 further comprising:
a memory module coupled to the processing module;
wherein the processing module executes a secure file transfer application that decodes the conditional access data from the optical storage disc and that stores the conditional access data in the first memory.

6. The portable game console of claim 5 wherein the memory module includes a removable memory stick.

7. The portable game console of claim 5 wherein the memory module stores the secure access application and a second video player application, wherein the processing module selectively executes the first video player application and the second video player application.

8. A universal media disc for use in a portable game console that includes a processing module, a interface module for receiving a video signal, and a display device, the universal media disc comprising:
a first portion that stores conditional access data; and
a second portion that stores a plurality of operational instructions including a video player application;
wherein when the universal media disc is loaded in the portable game console and when the plurality of operational instructions are executed by the processing module, the video player application descrambles the video signal received from the interface module using the conditional access data and displays video content from the video signal on the display device.

9. The universal media disc of claim 8 wherein the conditional access data includes at least one access key for descrambling the video signal.

10. The universal media disc of claim 9 wherein the conditional access data includes an expiration date and the at least one access key is not operational to descramble the video signal after the expiration date.

11. A method comprising:
receiving a video signal from an external device;
loading an optical storage disc that stores conditional access data and that stores a plurality of operational instructions including a video player application;
executing the video player application to descramble the video signal based on the conditional access data to produce a descrambled video signal, and to decode the video signal to produce a decoded video signal; and
displaying that decoded video signal.

12. The method of claim 11 wherein the optical storage disc includes a universal media disc.

13. The method of claim 11 wherein the conditional access data includes at least one access key for descrambling the video signal.

14. The method of claim 13 wherein the conditional access data includes an expiration date and the at least one access key is not operational to descramble the video signal after the expiration date.

15. The method of claim 11 wherein receiving the video signal receives the video signal via a interface module that includes at least one of, an Ethernet port, a universal serial bus port, and a wireless local area network port.

16. The method of claim 11 further comprising:
executing a secure file transfer application that decodes the conditional access data from the optical storage disc; and
storing the conditional access data in accordance with the secure file transfer application.

17. An optical storage disc for use in a handheld video player that includes a processing module, an interface module for receiving a video signal, and a display device, the optical storage disc comprising:
a first portion that stores conditional access data; and
a second portion that stores a plurality of operational instructions including a video player application;
wherein when the optical storage disc is loaded in the handheld video player and when the plurality of operational instructions are executed by the processing module, the video player application descrambles the video signal received from the interface module using the conditional access data and displays video content from the video signal on the display device.

18. The optical storage disc of claim 17 wherein the optical storage disc includes a universal media disc and the handheld video player is a portable game console.

19. The optical storage disc of claim 17 wherein the conditional access data includes at least one access key for descrambling the video signal.

20. The optical storage disc of claim 19 wherein the conditional access data includes an expiration date and the at least one access key is not operational to descramble the video signal after the expiration date.
